(19) United States
(12) Patent Application Publication
(10) Pub. No.: US 2009/0116471 A1
(43) Pub. Date: May 7, 2009

(54) Method for Enhancing Quality of Service in Mobile Telephony

(75) Inventors: Frederic Guichard, Paris (FR); Bruno Liege, Boulogne (FR); Jerome Meniere, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: DXO LABS, Boulogne Billancourt (FR)

(21) Appl. No.: 11/628,987

(22) PCT Filed: Jun. 8, 2005
(86) PCT No.: PCT/FR05/50429

§ 371 Date: Feb. 2, 2007

(30) Foreign Application Priority Data
Jun. 8, 2004 (FR) 0451132

(51) Int. Cl. H04J 3/06

(52) U.S. Cl. 370/350

(57) ABSTRACT

A method for enhancing quality of service concerning at least one multimedia data, in particular concerning photographs, and/or video, and/or audio, and/or text, involving least one processing of the data. The method includes determining, beforehand or in real time, based on the factor, a first fraction of the multimedia data to be processed in the mobile telephone, a second fraction of the multimedia data to be processed in at least one remote server connected to the mobile telephone via the network, a first fraction of the processing to be carried out in the mobile telephone, and a second fraction of the processing to be carried out in at least one remote server, and performing each fraction of the processing and/or processing each fraction of the multimedia data thus determined in the mobile telephone and/or in the remote server.

The invention relates to a method to improve the quality of using a service proposed to users of mobile telephone terminals by a service provider and/or a telecommunications' operator, such service relating to at least one type of multimedia data.

By “multimedia data” is meant here a photograph, a video, a sound file, an audiovisual file, a text file, a drawing(s) file, and/or one or several programme(s).

By “quality of using a service relating to a type of multimedia data” is meant here the quality of the multimedia data such as perceived by a user, the response time to a service as perceived by the user and/or the success rate of the service, for example the successful sending of the multimedia data.

The invention aims at overcoming the limitations resulting from at least one factor affecting the quality of using the service relating to the multimedia data. Such factors affecting the quality of use are included in the group comprising:
the size of the multimedia data; for example a type of multimedia data to be transmitted by a mobile telephone may not exceed the maximum size authorised by the network;
the IT resources of the mobile telephone; the mobile telephone memory may thus be insufficient for processing the multimedia data or the IT performance of the mobile telephone may be insufficient for processing the multimedia data within an acceptable time for the user;
the quality of the acquisition device and/or of the restitution device for the multimedia-data;
the network transmission specifications, namely its output, the size of the messages transmitted;
the services provided; for example, a photographic printing service can bring to flight the defects of the multimedia data, just like the noise, which are not visible when using a service to send the photograph to another mobile.

Thus, the method according to the invention includes the following steps:
shall be determined, a priori or in real time, depending on the said factor, a first fraction of the multimedia data which has to be processed inside the mobile telephone, a second fraction of the multimedia data which has to be processed inside at least one remote server connected to the mobile telephone via the network, a first fraction of the process having to be performed inside the mobile telephone and a second fraction of the process having to be performed inside at least one remote server, and
shall be carried out each fraction of the process thus determined and/or shall be processed each fraction of the multimedia data thus determined inside the mobile telephone and/or inside the remote server.

It should be noted here that the fractions mentioned above can adopt any value comprised between 0 and 1.

With the invention, thus not only the quality of using the services relating to the multimedia data inside the mobile telephones can be improved, but also they can be extended, and the time necessary for receiving the services is reduced.

For example, when the multimedia data is an image such as a photograph, the process can be shared between the mobile telephone and the server or the process can be carried out inside the server.

In an embodiment, the method includes the following steps:

shall be defined, in the mobile telephone, instructions relating to the process having to be performed inside the server, such process being referred to hereafter as the “remote process”,
the mobile telephone transmits these instructions to the remote server, and
the server carries out these instructions.

The instructions can include:
the second fraction of the multimedia data having to be processed inside the remote server, and/or
an identifier enabling at least one remote server to determine the second fraction of the multimedia data to be processed inside such remote server, and/or
the second fraction of the remote process having to be carried out inside the server, and/or
the address of the beneficiary of the service, and/or
a code enabling the server to obtain such beneficiary's address,

the method further including the step for the server to transmit, to the beneficiary of the service, the result of carrying out the instructions relating to the process.

According to a variant, the instructions relating to the process having to be carried out inside the server are defined in the server, particularly subsequent to communication with the mobile.

According to an embodiment, the fraction of the remote process includes at least one process contained in the group comprising:
an improvement of the multimedia data, such as a correction process for acquisition defects linked to one or several type(s) of mobile telephone,
a process destined to remove all or part of the defects of a means of restitution or of recording to which the data is destined, such as a screen, particularly of a mobile telephone, or such as any other display, or such as a means of printing,
a background clean up of the multimedia data, for example for the purpose of saving or printing such data, particularly when this is a photograph linked to a text and/or to a drawing done by hand,
an analysis of the quality of the multimedia data,
a desired retouching of the multimedia data such as, in the case of an image, its geometric shifting, namely by rotation or cropping,
a transmission, such as MMS, facsimile, e-mail,
associating an image to text,
sending to a recipient, to a service for creating multimedia data albums, to a recording service, a printing service, multimedia data page layout,
providing instructions by return to the mobile telephone for editing the multimedia data when this is sent via the mobile telephone, for example to insert photographs and/or texts, and
a service-providing process, for example sending a file to a printing service.

According to an embodiment, the method includes, inside the mobile telephone, a multimedia data compression step, for example compression of the JPEG type, such compression step including a pre-process in order to optimise the multimedia data size, its compression rate applied and its format, such pre-processing depending on at least one of the parameters included in the group comprising: the type of service required, the network transmission specifications, the optimal compression curve according to the multimedia data size and the multimedia data compression type,

the multimedia data compression preferably being implemented within the frequency domain,

the method further including a decompression inside the remote server with, preferably, an elimination process for the artefacts or defects linked to the compression.

The optimal compression curve/size of the multimedia data is determined in the following manner:

a) depending on the type of service, shall be determined the necessary size for the final use of the data; for example, in the case of a photograph, the size for using the data is 2 mega pixels in order to print in 10×15 cm format, 50 kilopixels in order to display on the screen of mobile telephone terminal and 300,000 pixels in order to display on a computer screen; in the case where such service is not known, the size considered for use is the size of the original multimedia data, or in another embodiment, the maximum necessary for all known services,

b) shall be determined the maximum size of the file for transmitting the multimedia data according to the network capacity and the other data factors to be transmitted,

c) shall be determined the optimal rate for sampling using a chart defined in advance based on multimedia data (namely from the images illustrated), the chart providing a value for the sampling rate depending on the maximum file size,

d) shall be determined the compression parameters depending on the contents of the multimedia data; for example the compression of an image must be that much higher, the more details there are. In an embodiment, several ranges of compression parameters are tested in order to obtain a file size equaling, as far as possible, the size required for the data's final use.

In an embodiment, the multimedia data is stored inside the remote server without compression, or without additional compression, or with low compression, or with additional low compression, and is compressed for transmission to the mobile telephone where it undergoes a process depending on the service to be provided, or requested by the mobile telephone, the processed and compressed data transmitted being allocated a markup linked to the original multimedia data stored without compression inside the remote server in order to enable its subsequent use without compression or at a more reduced compression than the processed and compressed data transmitted. By “compression” is mainly meant reducing the size of the data and/or sub-sampling.

According to an embodiment, the remote server comprises a base for mobile telephone signatures in order to be able to identify the origin and the multimedia data to be processed and to determine the type of process for each type of multimedia data, the signatures being extracted from the multimedia data or being appended to the multimedia data. The signatures may belong to any one of the following categories:
individual signatures for a single type of mobile telephone,
group signatures for several types of mobile telephones,
signatures corresponding to all types of mobile telephones.

According to an embodiment, the remote server occupies a position included within the following group:
an MMS centre, referred to as MMS-C,
at the entrance to an MMS-C,
at the exit of an MMS-C,
a WAP gateway, and
an MM9 or an MM7 interface of the MMS centre.

The invention also concerns a mobile telephone terminal comprising:

means for improving the quality of using a service relating to photos, and/or video, and/or audio, and/or text, implementing at least one process for such data, such service being proposed by a service provider and/or a telecommunications' operator inside the mobile telephone,

such means for improving the quality of use comprising:

means for determining, a priori or in real time, according to at least one factor affecting the quality of use, a first fraction of the multimedia data to be processed inside the mobile telephone, a second fraction of the multimedia data having to be processed inside at least one remote server connectable to the mobile telephone, a first fraction of the process having to be performed inside the mobile telephone and a second fraction of the process having to be performed inside a remote server,

means to perform the process or processes thus determined inside the mobile telephone, and

means for transmitting to the remote server the multimedia data or fraction of data having to be processed inside such server.

According to an embodiment, the terminal includes means for determining, inside such mobile telephone, the fractions of the multimedia data to be processed and/or the fractions of the process having to be performed, and/or the means for receiving information relating to the said fractions from a remote server.

According to an embodiment, the terminal includes means for transmitting to the remote server the instructions relating to the process having to be performed inside such server.

In an embodiment, the terminal is such that the instructions include:
the second fraction of the multimedia data having to be processed inside the remote server, and/or
an identifier enabling at least one remote server to determine the second fraction of the multimedia data to be processed inside such remote server, and/or
the second fraction of the remote process having to be performed inside the server, and/or
the address of the beneficiary of the service, and/or
a code enabling the server to obtain such beneficiary's address.

According to an embodiment, the means for determining the fraction of remote process having to be performed inside the server include the means for selecting such remote process when the process is included in the group comprising:
improvement of the multimedia data, such as a correction process for the acquisition defects linked to a type of mobile telephone,
a process destined to remove all or part of the defects from a means of restitution or of recording on which is destined the data, such as a screen, namely of a mobile telephone or of any other display, or of a means of printing,
editing the multimedia data,
a background clean up of the multimedia data, for example for the purpose of recording or printing such data, particularly when this is a photograph linked to a text and/or to a drawing done by hand,
an analysis of the quality of the multimedia data,
a desired retouching of the multimedia data such as, in the case of an image, its geometric shifting, namely by rotation or cropping,
a method of transmission, such as MMS, facsimile, e-mail,
associating an image to text, sending to a recipient, a service for creating multimedia data albums, a recording service, a printing service, multimedia data page layout, instructions to be provided by return to the mobile telephone for editing the multimedia data when this is sent via the mobile telephone, for example for inserting photographs and/or texts, and
a multimedia data process for providing the service, namely a change in format or size of the file containing the multimedia data.

According to an embodiment, the terminal includes means for compressing the multimedia data, for example means of the JPEG type, such compression means including pre-processing means in order to optimise the size of the multimedia data, its compression rate applied and its format, such pre-process depending on at least one of the parameters included in the group comprising: the type of service required, the network transmission specifications, the optimal compression curve according to the size of the multimedia data and the multimedia data compression type,

the multimedia data compression preferably being implemented within the frequency domain.

The invention also concerns a mobile telephone telecommunications network server comprising means for improving the quality of using a service relating to at least one type of multimedia data, namely relating to photos, and/or video, and/or audio, and/or text, implementing at least one process for such data, the means for improving the quality of use including:

means for determining, according to a factor affecting the quality of using the service by the mobile telephone, a first fraction of the multimedia data which has to be processed inside the mobile telephone, a second fraction of the multimedia data which has to be processed inside at least one remote server connected to the mobile telephone via the network, a first fraction of the process having to be performed inside the mobile telephone and a second fraction of the process having to be performed inside at least one remote server,

means for transmitting the said fraction values to the mobile telephone, and

means for performing the fraction(s) of the multimedia data process having to be performed inside such server.

According to an embodiment, the server includes means for performing at least one of the processes included in the group comprising:
improvement of the multimedia data, such as a correction process for the acquisition defects linked to a type of mobile telephone,
a process destined to remove all or part of the defects from a means of restitution or of recording on which is destined the data, such as a screen, namely of a mobile telephone or of any other display, or of a means of printing,
editing the multimedia data,
a background clean up of the multimedia data, for example for the purpose of recording or printing such data, particularly when this is a photograph linked to a text and/or to a drawing done by hand,
an analysis of the quality of the multimedia data,
a desired retouching of the multimedia data such as, in the case of an image, its geometric shifting, namely by rotation or cropping,
a method of transmission, such as MMS, facsimile, e-mail,
associating an image to text, sending to a recipient, a service for creating multimedia data albums, a recording service, a printing service, multimedia data page layout, instructions to be provided by return to the mobile telephone for editing the multimedia data when this is sent via the mobile telephone, for example to insert photographs and/or texts, and
a multimedia data process for providing the service, namely a change in format or size of the file containing the multimedia data.

According to an embodiment, the server includes means for storing multimedia data without compression, or without additional compression, or with additional low compression in relation to the multimedia data received from a mobile telephone and for transmitting such compressed data to mobile telephones and in order to allocate a markup to such multimedia data.

According to an embodiment, the server comprises a base for mobile telephone signatures in order to be able to identify the origin and the multimedia data to be processed and to determine the type of process for each type of multimedia data,

the signatures being extracted from the multimedia data or being appended to the multimedia data.

In such a case, the signatures may belong to one of the following categories:
individual signatures for a single type of mobile telephone,
group signatures for several types of mobile telephones,
signatures corresponding to all types of mobile telephones.

According to an embodiment, the remote server shall occupy a position included among the following group:
an MMS centre, referred to as MMS-C,
at the entrance to an MMS-C,
at the exit of an MMS-C,
a WAP gateway, and
an MM9 or an MM7 interface of the MMS centre.

Other characteristics and advantages of the invention shall come to light in the description of some of its methods of embodiment, these being performed by referring to the sketches attached hereto whereby:

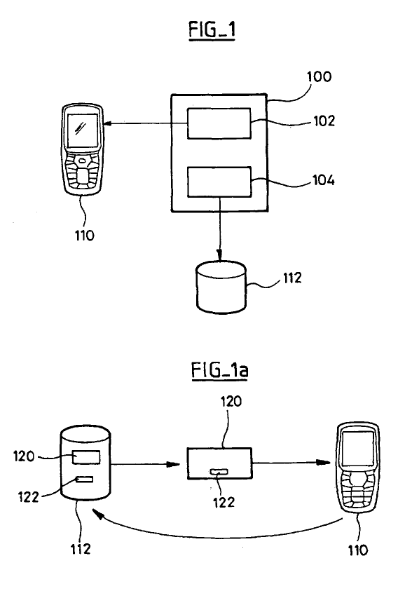

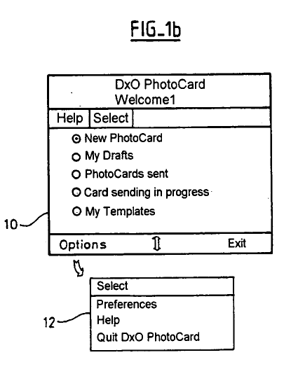

FIGS. 1 and 1a illustrate the steps of a method according to the invention,

FIGS. 1b, 2a, 2b, 2c, 3, 4, 5, 6, 7 and 8 refer to an embodiment example of the invention for a service sending postcards,

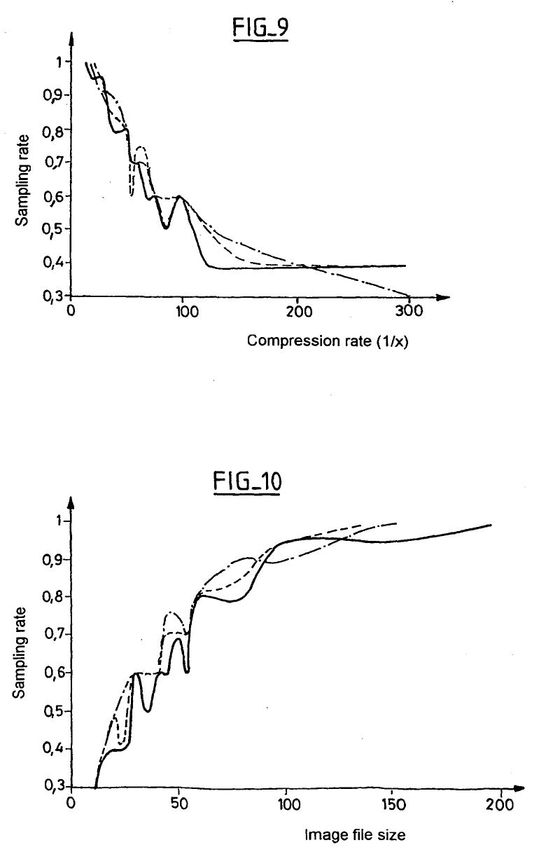

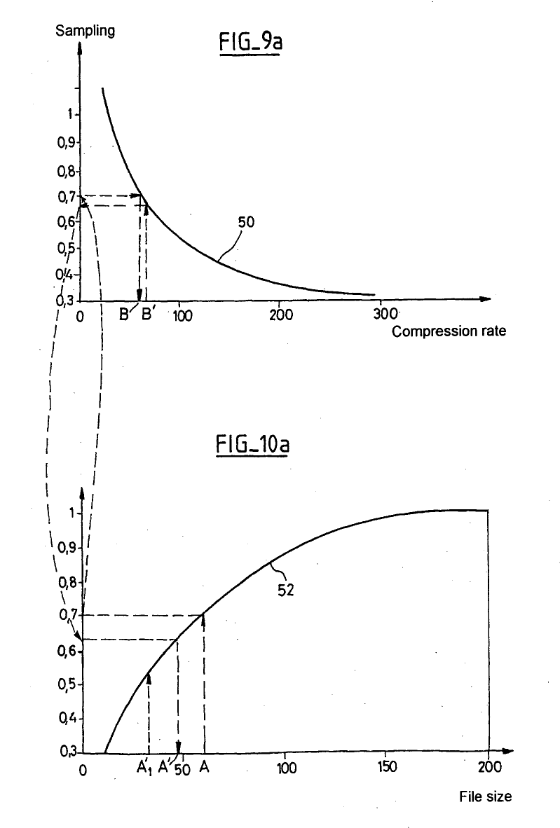

FIGS. 9, 10, 9a and 10a are charts illustrating a method complying with the invention, enabling to adapt the sending of image data to the capacity of a transmission network.

The examples described mainly refer to a mobile telephone terminal equipped with a picture-taking device, often known as a “photophone” or a “cameraphone”.

Using the Services

Using such terminals is tedious, especially when it concerns:
configuring a telephone to send images (via MMS, WAP, etc.),
parametering a service for a provider; for example, in order to record for an on-line printing service, it is necessary to provide one's personal details, choose a pick-up point, etc.
keying in text to accompany the photo or an address: inputting text is rather time-consuming, the postal address is rarely incorporated in the address book, etc.,
using a service: it is often necessary to use several functions one after the other, such as taking a picture, retouching and sending; the design of the applications is more function-oriented (camera, MMS) rather than adapted to an image service; some operations thus take some time,
using the terminal in place of a camera.

Image Quality

The image quality is limited due to the reduced dimensions, electricity consumption and mobile terminal costs.

The quality is variable depending on the terminal type and requires specific image processing. The image quality depends on the how the image is viewed. In particular, on a tiny screen many defects are invisible, while on a large-size screen or on a print-out, such defects become visible.

The images are highly compressed for the purpose of being stored inside the authorised pass-band, which produces artefacts during the decompression required for displaying or printing the images.

Thus we have particularly troublesome drawbacks which hinder the development of using photo services with a mobile telephone terminal due to such services being much less efficient than those linked to dedicated cameras.

Architecture

The calculation time for improving images is generally proportional to the size of the image, i.e. to the number of pixels.

Improving the quality of the image takes up considerable calculation time and thus electricity. The capacity of the processors integrated into the terminals increases less quickly than the number of pixels from the sensors.

The IT performance is limited and varies according to the terminal type.

Access to the IT performance is variable depending on the terminal type: certain terminals accept code written in C++, some only accept Java code (much slower for image processing than C++), others are not open to coding.

The local storage capacity is limited.

The size of the transmission pipes is limited. In France, it corresponds to 50 ko per message, passing gradually to 100 ko.

Images transit systematically by a server for the various services.

In order to resolve these problems, the invention improves the image quality and/or improves the design for use.

The method according to the invention intervenes prior to taking a picture and/or during picture-taking and/or after taking a picture.

Thus, as illustrated in FIG. 1, starting from an image 100, or, more generally, from a type of multimedia data, shall be determined a first fraction 102 of such data which has to be processed inside the mobile telephone 110 and a second fraction 104 of the image 100 which has to be processed in a remote server 112.

As a variant, and as described hereafter in relation to FIGS. 1b to 8, the processing of all the multimedia data (or a part of it) shall be split up in order for a first fraction of the process to be performed inside the terminal 110 and for a second fraction of the process to be performed inside the server 112.

In the example shown in FIG. 1a, the multimedia data 120 is stored without additional compression or with additional low compression in the remote server 112. It is compressed for transmission to the mobile telephone 110. It also undergoes a process depending on the service to be provided to such telephone 110 or requested by such telephone 110. Furthermore, the data 120 is allocated a markup 122 linked to such data. Such markup is transmitted with the data of the server towards the terminal 110 in order to allow subsequent use of the same non-compressed original data 120 when it is required by the mobile terminal or another mobile terminal. In other words, when the mobile terminal receives an image and wants to transmit it to another mobile terminal, in order to prevent deterioration due to the compression and to successive decompressions, the multimedia data can retrieve its original quality in the server 112 by way of the markup.

1. Services

1.1. The Various Services Considered Using the Image are:
Sending a facsimile from a terminal,
Sending towards another terminal,
Sending towards an e-mail,
Sending towards an on-line album,
Sending towards a personal Internet site (“moblog” in English),
Sending a postcard,
Sending a request for printing,
Sending a request for passport photos,
Requesting feedback onto the issuing terminal.

1.2. For Each One of the Services:

Taking a picture and/or searching in an album and/or retouching with improvement of the picture taken (lessons, framing assistance, verification, etc.),
the user design is improved,
the image quality is improved, as described below, by carrying out a local process and/or a process transferred towards a server,
a text photo is used where necessary (sometimes called “FotoText+”).

1.3. In Order to Send a Facsimile (Fax) from a Terminal, the Procedure is as Follows:
a picture is taken of a document containing the text and/or the drawings,
a background clean up is performed,
   locally (in the terminal), or
   remotely on a server with dispatch towards a fax machine,
text can be keyed in,
layout of the fax is possible,
it can be sent via MMS, WAP, http, etc., or directly from the terminal towards a fax machine, if the process is local.

In order to send a facsimile from a terminal, the following procedure is also possible:
Taking a picture of a document containing the text and/or the drawings,
Background clean-up process inside the terminal,
Possible text input,
Fax layout,
Sending via MMS, WAP, http, etc. towards a server or directly from the terminal towards a fax machine.

In order to send a facsimile from a terminal, it is also possible to use another procedure:
Taking a picture of a document containing the text and/or the drawings,
Possible text input,
Sending via MMS, WAP, http, etc. towards a server,
Background clean-up process inside the terminal,
Fax layout,
Dispatch towards a fax machine.

1.4. A Passport Photo Service Includes, in the Embodiment, the Following Steps:
Picture-taking with framing assistance.

Such framing assistance can be adapted to country standards for official documents.
The framing assistance enables to segment the image in order to more easily carry out the check points below.
Verifying compliance with the rules:
   The rules which can be verified are, for example:
   checking for a uniform background,
   checking the background colour,
   checking for adequate background brightness,
   checking for background shading,
   checking the brightness of the face (which should not be too dark),
   making sure there is no hat or veil,
   making sure there are no accessories,
   checking the proportions of the face,
   making sure that the photo is taken full face and not of a profile.

Verifications can be automatic and/or manual.

Should rules not be observed:
preferably correction is automatic, and/or
correction is carried out manually by an operator, for example, for background clean up,
otherwise a message is sent back to the user, preferably rapidly, so that he/she may retake a photograph.

Such message indicates, for example, how to retake a photo without the defect.
Possible text input to be written on the back of the photo, for example:
   the name
   the name and class reference for a school photo.
Input of the recipient's postal address or of the photo pick-up point.
Possible choice of service provider.
Possible retouching of the image (background clean up, contrast, etc.). The retouching is done manually, via automatic photo transmission to an operator, and/or automatically.
Transmission.

This service can be adapted to country rules for official documents.

1.5. Other Possible Services with a Cameraphone (or Photophone):
Character recognition.
Face recognition.
Bar code reading.
Managing rights and digital signatures (“watermark”).
Personal Mobile Website (“blog”).
Text templates and photos, for example for Mother's Day or St. Valentine's Day or even for excerpts of poetry.
Medical SOS, for extreme situations, for example out at sea or up in the mountains.
Jointly agreed statement in the event of a car accident. An application asks questions and indicates the photos to be taken for drawing up a report.
Tele-diagnosis, for example for a sick plant.
Practical services
   Measurements: for example, measuring a piece of furniture or other object on which an item having pre-defined dimensions, such as a credit card, is juxtaposed.
   Colour: calculating a colour combination between two items. For example, matching colours between a pair of trousers and a pair of shoes, or between a tie and a shirt.
Miscellaneous services
   Morpho astrology: every day a personalised horoscope, calculated using one's date of birth and face.
   “Morpho matching”: evaluating the level of friendship between two persons, such level being based on photos of their faces.
   Aura: adding a coloured “aura” to the person (or the item) on the photo.
Security and identification or authentication Signature: the written signature (added to a number generated by a server, for example) can be used as authentication.
   The photograph can also be used as authentication.
Services for professionals:
   Estimate: the tradesman on call to prepare an estimate often needs to consult a specialist. The cameraphone provides a means for consulting with the fitter/supplier when drawing up the estimate. For example, a fitter of a motor for roller blinds can contact a roller blinds' fitter to determine the difficulties for dismantling.

It is also possible to receive approval from a customer for choices emerging at a late stage, for the purpose of avoiding delays or errors of appreciation, for example, for authorising a more severe tree-felling than originally planned, showing the roots preventing the digging of a trench with the cameraphone.

2. Improving the Quality of the Image and Page Layout

After taking a picture, several techniques can be used to improve the image quality and the user design:
Carrying out processes to improve the image.
Depending on the terminal's IT performance, its memory capacity, the size of the sensor, the type of service and the ease of adding functions to the terminal, processes may be carried out on the terminal or on a server. In such a case, a data transmission format shall be defined.
Adapting processes to the defects of the capture device. In such a case, shall be identified the origin of the images, namely by analysing the signature of the device.
Adapting processes to the defects of the restitution means. Hence it is necessary to identify the type of service and, possibly, the type of restitution means used and then to transmit such information.

In the case of a process on a server, the process consists of:
extracting the image from the message transmitted,
improving the image quality,
replacing the transmitted message image by the image so improved.

In order not to correct the images twice over, these can be marked, for example, by adding or modifying the Exif or similar metadata.

It should be noted here that by metadata is meant data linked to the multimedia data and corresponding to information relating to the format of the file containing the multimedia data, and/or to the information relating to the compression, and/or to the origin of the data, and/or to the acquisition specifications. For example, in the case of a photograph, the acquisition parameters (such as the focus, the opening and the exposure time), and/or the results of calculation obtained using the multimedia data, such as the number of pixels.

Processing the image can be carried out in various ways:

a) No calculation is made locally (i.e. in the terminal) and the image is sent back to the user (i.e. terminal) after remote calculation (in a server).

b) Local calculation is made according to the terminal screen's resolution and a remote calculation is made for the image transmitted by the service.

c) Local calculation is made of the terminal screen's resolution and, for the image transmitted by the service, decompression is performed inside the server in addition to a clean-up of the compression artefacts prior to sending, the image processing transmitted for the service being able to be done locally and/or remotely.

In all events, the remote image transmission must be done by adapting the size and the compression to the service, as well as to the authorised message size, as described hereafter.

Similarly, the page layout can be performed locally or remotely:

a) No calculation is made locally, such calculation for the image transmitted by the service being done remotely and then returned to the user.

b) Local calculation is made according to the terminal screen's resolution and a remote calculation is made for the image transmitted by the service.

c) Local calculation is made of the terminal screen's resolution and, for the image transmitted by the service, decompression is performed inside the server in addition to a clean-up of the compression artefacts prior to sending.

Of course, the method described above can be applied to other types of multimedia data, namely relating to video, and/or audio, and/or text.

Thus can be obtained a method and a system to improve the quality of using a service, implementing at least a process, relating to at least one multimedia data, namely relating to photos, and/or video, and/or audio, and/or text, such service being proposed by a service provider and/or a telecommunications' operator inside a user's mobile telephone via a network.

Let us be reminded that this process is adapted to overcome the limitations resulting from at least one factor, affecting the quality of use, such as:
the size of the multimedia data, and/or
the IT resources of the mobile telephone, and/or
the quality of the multimedia data's acquisition device and/or the restitution device
the transmission specifications of the said network,
the type of service.

Thus, the method includes the following steps:
shall be determined, a priori or in real time, according to the said factor, the fraction of the multimedia data and/or the fraction of the process having to be processed inside the mobile telephone and/or inside at least one remote server connectable to the mobile telephone,
shall be performed each fraction of the process thus determined and/or shall be processed each fraction of the multimedia data thus determined, either inside the mobile telephone, or inside the remote server, whichever the case;

so that, for the user, the quality of the service is increased, namely:
the service can be used with any type of multimedia data, for example photographs of an increasing size,
use of the service is improved for every terminal type,
the outcome of the service is improved in connection with the network's pass-band,
access to the service is simplified,
the time required to obtain the service is reduced,
the outcome of the service is improved (better photograph, video, audio perception),
access to new services is possible,
user satisfaction is increased.

For the service provider and/or the telecommunications' operator, new services can be provided.

This method can further include the following steps:
defining instructions relating to the remote process by means of a format,
for the mobile telephone, transmitting the instructions thus formatted to the remote server,
for the server, carrying out these instructions.

Such instructions may include:
the fraction of the multimedia data and/or an identifier enabling the server to obtain such fraction of the multimedia data,
the fraction of the process having to be performed on the server, hereafter referred to as the “remote process”, namely:
a process to improve the quality of the multimedia data, and/or
a retouching process of the multimedia data, and/or
an editing process of the multimedia data, and/or
a process to dispatch the service, and/or
a process to provide the service, and/or
the address of the beneficiary of the service and/or a code enabling the server to obtain the beneficiary's address.

The method further includes the step, for the server, to transmit the results of carrying out the instructions to the beneficiary of the service.

By “service” is particularly meant:
any service, namely the services described within this patent request,
a portion of a more comprehensive service, for example, remote calculation required by a service,

By “photo” is particularly meant:
a photo text and/or diagram and/or natural image.

By “process”, also called “correction”, is particularly meant:
all types of process described in this patent request,
a process to improve the quality,
a process to improve the quality, adapted to a telephone,
insertion into an album,
page layout,
sending.

By “IT resources” is particularly meant:
the IT performance,
the memory capacity,
the programming language.

By “transmission specifications” is particularly meant:
the pass-band,
the load,
the maximum size of the message.

By “identifier” is particularly meant:
an image code (transmitted to the server by SMS or other means), enabling a server to find the image chosen by the user.

By “code” is particularly meant:
a telephone number used to find out a postal address.

By “beneficiary” is particularly mean:
the user,
a third party.

By “instruction” is particularly meant, the data described in this patent request.

2.1. Types of Image Processing

The processes made to the images inside the terminal and/or on the server can be the following:
Removing or reducing all or part of the defects of the picture-taking device and/or from the picture taken: exposure, lighting, geometric distortion, chromatic aberration, vignetting, blurring, astigmatism, white balance, saturation, dematrixing, noise, movement blurring, focus blurring, compression artefact, unblurring artefact, artefact for other processes, aliasing artefact.

Removing all or part of the defects from the restitution means: terminal screen, computer screen, printing means.
Changing the size (number of pixels).
Compression.
Decompression with or without eliminating the artefacts.
Background clean-up in the case of a text and/or a drawing.
Retouching: converting to black and white, rotating, extracting an image zone, applying effects, adding a frame.
Inlay on a background or another photograph.
Adding text.
Analysing the image quality in order to give advice to the user.

2.2. Instructions for Remote Process

It is possible to transfer a part of the processes depending on the terminal's capacity, on the memory capacity, on the image size, on the possibility to programme the terminal in C++ as opposed to Java programming, which is badly adapted for processing multimedia data, and on the type of service desired. For the user, processes remain in real time for operations requiring feedback to such user.

Information enabling to describe the transferred process (for each image, or once and for all) must be transmitted, namely:

a) The type of improvement process to be made on the server. This concerns, for example:
Correction of the terminal capture defects of the data type for visualising on a computer screen.
Correction of the terminal capture defects of the picture-taking type with automatic recognition for visualising on a computer screen.
Correction of the terminal capture defects of the picture-taking type with automatic recognition for printer output.
Background clean-up for text photos and hand-drawn sketches.
Correction of the picture-taking terminal capture defects with automatic recognition for visualising on a terminal screen of the data type.
Picture-taking quality analysis.

Even if no process is to be performed, such instruction must be transmitted, possibly by default.

b) Retouching to be made to the image (rotation, cropping, adding a frame, etc.), which enables retouching inside the terminal on an image reduced to the size of the screen and subsequent retouching when at the final size.

c) The types of services and their recipient(s):
MMS: numbers.
e-mail: addresses.
Postcard: service provider.
Facsimile: number.
Album: service provider.
Printing: service provider.
Feedback onto the issuing terminal.

d) Output editing indications:
Page layout (particularly colour and font) for postcards or other,
Inserting photos, text, or cleaned-up photographed text.

The editing data must be separate from the physical format in order to enable printing in several formats. The size and position of the text and image elements are determined downstream.

e) The contents:
address of the recipient (postal or other)
message
photo
text photo

Such contents can be transmitted as an address and/or metadata.

The contents can be described by a format. Such format can be open (standard and/or extensible); it can be an extension of the MMS “SMIL” format. It must be compatible with all types of dispatch protocol (MMS, http, WAP, e-mail, etc.) and thus compatible with the existing networks.

2.3. Recognition of the Picture-Taking Device.

According to an embodiment, the remote server comprises a base for mobile telephone signatures in order to be able to recognise the origin of the multimedia data to be processed and to determine the type of process for each type of multimedia data, the signatures being extracted from the multimedia data or being attached to the multimedia data.

In order to recognise the origin of the multimedia data, an analysis of the multimedia signature is made, which enables to apply the adapted process.

Now, we are going to describe an embodiment example when the multimedia data is a photo.

The signature information included in the image can be used: JPEG comment, Exif, quantification table, or other metadata, for the purpose of constituting a base for the signatures with, for each signature, the type of correction to be made.

This is particularly interesting for the case where the terminal having taken the photo is not known by the processing server, either because the photo does not originate from the issuing terminal, or because the type of issuing terminal (“user agent” or equivalent) is unavailable.

Automatic recognition of the device capturing the image can be activated according to the following steps:
A base of possible signatures is created for each terminal included in a group of terminals.
For each signature is determined the process or the corrections to be made, for example, in terms of decompression artefacts, of sharpness, of colour, of contrast, or of noise. Such corrections can be:
   corrections adapted to one type of terminal, if the signature only refers to a particular type of terminal;
   corrections adapted to several types of terminals, for example, when several terminals have the same signature and such terminals have common specifications; or
   corrections adapted to all types of terminals, for example in the case of ambiguity, where applying an adapted correction to this signature is not possible or not desired.
A terminal's signature is determined using the image file.
The type of correction to be made is determined using the signature and the base of signatures.

The base of signatures is updated regularly and is preferably done prior to the device being put on the market in order minimise the number of unknown signatures and thus of non-adapted corrections.

Several types of terminals may have the same signature. In such a case, a compatible correction can be created for such different terminals.

It should be reminded here that it is possible to use the same correction for every terminal type. This solution has the advantage of being simple but does not optimise correction.

Certain terminals can have several signatures: in such a case, the various signatures are added to the base.

The signature is composed of all or part of the following information:
the JPEG quantification table,
the comments,
the JPEG sub-sampling,
the image size,
Exif data: “Maker” and “Model” fields,
Exif data: other fields,
specifications measured using the image.

In order to determine correction, particularly in the event of doubt, can also be used:
the type of the issuing terminal, which although provides the origin in an uncertain manner does remove any ambiguity. For this purpose, the “user agent” shall for example be used, which corresponds to the type of device and is transmitted by the said device, or even a signature from the message itself for the format variants used. For example, in the case where the message is an “MMS”, the name of the attached files, their order, the file contents in xml “SMIL” format integrated into the message, all constitute a message signature enabling to locate the type of terminal having created it. In fact, even though there exists a coding standard for “MMS” messages, each terminal codes a message in a specific manner while observing the standard, or
the history of signatures on the telephone number of the person issuing the photo.

An example of the signature coding is as follows:

Auto#13,9,9,13,18,20,24,23#211#0#1280×960#tutu|titi|glouglou#0220#SO505i#DoCoMo#

In this example, the various fields are separated by the “#” sign and are explained below:

1. Auto: information of the device type which can contain either “auto” to mean that no information is available, or can contain a device identifier determined otherwise, for example as described above using the “user agent” or from a message signature itself.

2. 13,9,9,13,18,20,24,23: contains the first n coefficients from the luminance quantification table (channel Y), such as given in the JPEG heading.

3. 211: format of the JPEG sub-sampling in number form comprising 3 or 4 figures.

4. 0: JPEG tag value “saw_JFIF_marker” (which equals 1 or 0).

5. 1280×960: height and width of the image in number of pixels.

6. All or part of the JPEG comment.

7. The following fields contain information on Exif:
indicates whether Exif exists or not, and if so, the version is given. Otherwise, “NoExif” is written.
If Exif exists, the “model” field is contained, corresponding to the device model.
If Exif exists, the “maker” field is contained, corresponding to the device manufacturer.

2.4. Transferred Processing of an Image

Preferably, in order to code the images for their transmission, a JPEG standard compression programme is used, which is implemented in all telephones; however, another format may be used. The image processing steps are as follows:
Possibly pre-processing.
Possibly optimisation of the image size, the compression rate, the image format (such format also includes colour choice and black & white) depending on the type of service and on the size of the transmission “pipe”:
   by taking account of the optimal compression curve/image size according to the service and the pipe size, as described below, if the image is already compressed, the compression and size change are preferably carried out in the frequency domain in order to limit the calculation time,
   otherwise compression takes place after changing the size.
Inside the server:

Everything is decompressed by eliminating the compression artefacts; then:
all or part of the picture-taking device's defects are removed or reduced, or, in the case of a text photo and/or a drawing (FotoText+), the background is cleaned up, all or part of the defects of the restitution means are removed,
all other processes are applied: retouching, page layout, etc.,
the image is marked to prevent applying the process several times over.

The transfer is performed via MMS, surcharged MMS, e-mail, http, WAP or other means.

The message can be sent to a third party and/or used on the issuing terminal, for example to visualise the outcome or to receive advice.

2.5. Local Processing of a Service

Preferably, in order to code the images for their transmission, a JPEG standard compression programme installed in all terminals is used; however, another format can also be used. The image-processing steps are as follows:

a) Possibly pre-processing.

b) Then:
removing or reducing all or part of the picture-taking device's defects or, in the case of a text photo and/or a drawing (FotoText+), performing a background clean-up,
removing all or part of the defects of the restitution means,
applying the other processes: retouching, page layout, for example.

c) Mark the image to avoid applying the same processes several times over;

possibly optimise the image size, the compression rate, and the image format depending on the type of service and the pipe size:
by taking account of the optimal compression curve/image size according to the service and the pipe size,
if the image is already compressed, the compression and size change are preferably performed in the frequency domain in order to limit calculation time,
otherwise compression is carried out after changing the size.

d) For services using a large-size image:
inside the server, a decompression is carried out eliminating the compression artefacts, followed by, where necessary, an enlargement up to the size of use.

Transfer can be performed directly towards the final user (except in the case of a postcard) or via a service provider.

2.6. Storage

In an embodiment, the multimedia data is stored without additional compression or with low additional compression inside the remote server and is compressed for transmission to the mobile telephone, and it undergoes a process depending on the service to be provided, or requested by the mobile telephone, the compressed and processed data transmitted being allocated a markup linked to the original multimedia data stored without compression inside the remote server in order to enable its subsequent use without compression or with a lower compression than the processed and compressed data transmitted. By storage without compression is meant storage prior to compression or size reduction, or failing that with low compression and/or a slight size reduction.

In the case where the image is compressed or reduced prior to transmission to the recipient for the purpose of optimising output, images can be stored inside the server prior to compression or size reduction in order to allow the use of all the services with maximum quality by the recipient of a message. Such facility enables in fact to use services at a later date for this same image: for example, terminal A sends terminal B an image by MMS, and terminal B transmits this image towards a postcard service based on the image stored inside the server.

In order to do so, the following steps are necessary:
store the original image inside a server and index it using an identifier,
apply the processes, particularly the processes adapted to the service requested, though not compatible with all the services,
mark the image in a persistent manner using an identifier,
transmit the image.

When the image transits again via the server:
the identifier can be extracted using the markup,
the corresponding indexed original image is then located,
the image can be replaced by the indexed large-size image as necessary.

Currently, a server's hard disk is able to store approximately 5 million images.

The advantages obtained by such storage are the optimal quality, a reduced pass-band for transmission, and compatibility with all types of terminals.

2.7. System

The remote server, also called “correction server”, can be positioned:
inside the MMS-C (MMS processing system hosted by the operator),
at the entrance to the MMS-C,
at the exit of the MMS-C,
inside the WAP gateway,
inside the MM9
inside the MM7.

The following terminal and server combinations are possible:
standard terminal and server,
terminal with image-processing application, without a server,
terminal with image-processing application, with server,
terminal with application, though not processing, with server,
terminal with pre-processing application to give a preview to the user by way of a reduced-size image, with server.

The processes providing feedback to the user can be achieved:
locally (inside the terminal), or
remotely via http or another protocol.

2.8. Adapting the Image to the Size of the Pipe

The telecommunications' operators limit the size of messages transmitted, for example by MMS.

The size of an image file depends upon the contents of the image. For a given number of pixels and a given perceived level of quality, an image containing much detail will generate a file considerably larger than an image containing less detail.

It is thus necessary to automatically adapt the level of quality to enable the use of a service in all cases and not to exceed the pass-band allocated by the operator.

Several ways of adapting this level of quality exist, with the main point depending upon the use and thus the service type.

When using a service, the images adopt the following pattern:

a) Taking a picture and possible compression.

b) Pre-processing in order to optimise the size of the multimedia data, its compression rate applied and its format: adapting the pass-band allocated by the operator, by reducing the size of the file transmitted, such reduction being performed via a possible reduction in the number of pixels, and/or an increase in the rate of compression.

c) Decompression with, preferably, a reduction of artefacts.

d) Change in the number of pixels for the purpose of adapting to the screen or the printer used for the service (final number of pixels).

In order to reduce the file size, a compromise exists between the number of pixels and the compression used:
such compromise depends upon the final number of pixels and thus upon the type of service required and the decompression process, particularly whether the artefacts are to be reduced or not;
beyond a certain level of compression, it is advisable to reduce the number of pixels.

The file size reduction operations can take place:
preferably without decompressing the image within the frequency area, or
after image decompression, or
after image decompression and reduction of the artefacts.

2.9. Application Examples

Examples of process-distribution are set out below:

a) Application with a 3G network

Such network enables fast terminal-server exchanges. It is thus possible to carry out processes inside the server and to rapidly display the outcome on the telephone.

Hence it is possible to work with any IT performance on the terminal and with a high number of pixels.

b) Application with a 2.5G and a top-of-the-range telephone (“Smartphone” in English).

The network does not enable fast terminal-server exchanges. However, the terminal has a high IT performance.

It is thus possible to carry out image processing inside the terminal according to the screen size in order to show a preview to the user and to rapidly display the outcome on the telephone.

It is thus possible to carry out full resolution processing on the server without requiring feedback towards the user.

c) Application with a 2.5G network and a middle-of-the-range telephone (“Featurephone” in English).

The network does not enable fast terminal-server exchanges.

The terminal has limited IT performance and exchanges are slow. The availability of previews for the user shall be more limited, although the other advantage (design, accessibility to services, etc.) are maintained.

It is thus possible to carry out processes inside the server by limiting feedback towards the user.

3. Photography-Text Solution (FotoText+component)
background clean-up

The invention allows for a component, called “FotoText+”, which is a text scanner enabling to transform a photo taken of any document “of the binary type”, for example comprised of strokes on a clear background, particularly a handwritten text, an outline drawing, map or sketch, a printed text.

This component corrects the paper defects (background clean-up): the paper's shading, squares or lines, folds, stains, crumpling, and, of course, the camera and lighting defects. This can be done by extracting information above a threshold.

It optimises the contrast level.

It performs an automatic correction of the focussing “close-up blurring”, for example by applying an unblurring mask. Indeed, cameraphones are programmed for 80 cm sharpness to infinity and, in general, do not have auto-focus. However, the photo of a text is taken at a distance of approximately 15 cm, i.e. within the blur range of the cameraphone.

If this defect is hardly sensitive to very low resolutions (such as that on a screen: 160×120, or CIF), it is particularly sensitive as of 300,000 pixels (VGA).

It also corrects the calorimetric defects.

It is compatible with very high compression. Thus, a text photo representing approximately 25 ko, only represents a maximum of 5 ko after compression—in order to optimise transfer.

After decompression, then processing, the image is put back into printing format for an improved superimposition on a background: enlargement up to 300 points per inch or according to the format of the final document.

The component produces level grey strokes on a uniform background.

It can be used in various manners:
alone:
to display, after picture-taking, on a terminal screen, seeing as the processed image is more readable than the original image,
to send to another recipient (by MMS or other),
on the reverse side of a postcard (message and/or address);
illustrating an image:
using a touch-up software, which enables to superimpose the cleaned-up image on a photo by making the background colour transparent through a mixing operation between the photo and a uniform colour or a texture while using the cleaned-up image as a mask. For each pixel, if the grey level of the cleaned-up image has an IN value, the photo has a PH value and the uniform colour or texture has a CO value, we take CO*(1−IN)/MAXIN+PH*IN/MAXIN where MAXIN is the maximum value of all the pixels in the cleaned-up image.

For example, for a postcard, the user takes two photos:

a) the photo for the front side of the postcard, and

b) the photo of a written/drawn text/graphic on a piece of paper.

A user interface enables to position the text/graphic onto the front-side of the photo; a local or remote terminal screen resolution process enables to display a preview, thus facilitating the work of the user.

The photo of the text/graphic is processed, cleaned by eliminating the non-uniform lighting zones to enhance readability, cleaned on its background and printed on the front-side of the photo.

In the case of a photo, particularly a passport photo, the background cleaning consists of making uniform all parts of the photo other than the actual person photographed, for example by detecting the outline of the face and filling the surrounds with a uniform colour.

4. Examples of Services

Described below, using FIGS. 1b to 8, is a postcard-making service, also called “photocard”.

The figures illustrate the various screens (man/machine interface) of the terminal when using this service.

Screen 10 illustrated in FIG. 1b corresponds to the welcome after selecting the postcard service. It concerns a welcome screen which offers, when activated, the choice between several actions which are, as represented: “new photocards”, “draft”, “cards sent”, “card sending in progress”, “templates”. The choice is made using the terminal's “joystick” by selecting one of the actions.

It is also possible to activate the “options” menu which then displays a screen 12 enabling the user to select the action, the preferences, assistance, or even to quit the service.

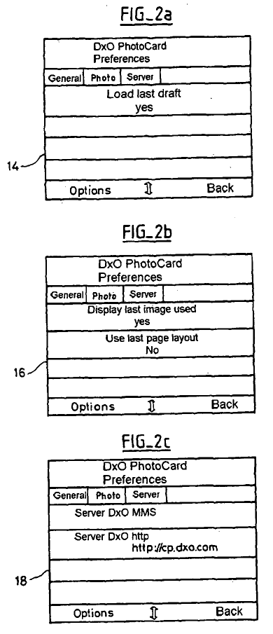

When selecting preferences, shown in the example in FIGS. 2a, 2b and 2c, the user can choose among three preferences, namely “general” (FIG. 2a), “photo” (FIG. 2b) and “server” (FIG. 2c), by using the left or right joystick.

On the screen 14 in FIG. 2a, corresponding to the “general” tab, the user is asked if he/she wants to automatically load his/her last draft.

On the screen 16 (FIG. 2b) corresponding to the “photo” tab of the preference section, the user is asked if he/she wants to automatically display the last image used and if he/she wants to automatically use the last page layout.

On the screen 18 of FIG. 2c, corresponding to the “server” tab of the preferences menu, the user is asked to which server he/she wants to connect, such as an MMS or http server.

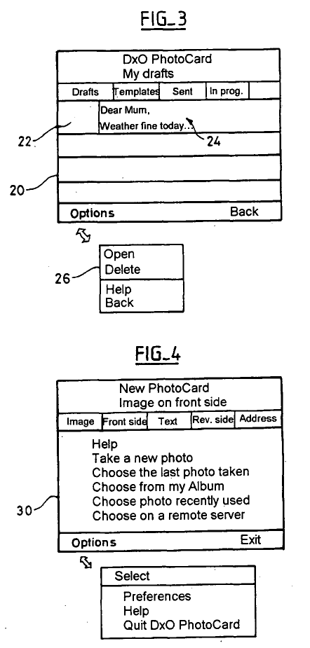

On FIG. 3 is shown screen 20, as displayed when the user selects an action with the “Select” option menu of the screen 12 of FIG. 1b. Thus, screen 20 is shown on which are displayed the available options between draft, template, card to be sent and card sending in progress. On screen 20, the latest draft is shown which comprises a photo 22 and a text 24. The menu option of screen 20 enables to access a screen 26 with the “open” command.

When choosing such “open” command, or when selecting the creation and sending of a new postcard on FIG. 1b, it is possible to select an image for the “front side” (page layout), text for the “reverse side” (page layout) and the address, as shown in FIG. 4.

The screen 30 illustrated in FIG. 4 corresponds to the selection of an image which, as shown, indicates that it concerns the service for creating a new postcard with the image on the front side, providing the possibility to take a new photograph, to choose the last photo taken, to choose the photo from an album stored in the terminal's memory, to choose a photo recently used for the same service, or finally to choose a photo from a remote server.

When choosing the “front side” tab (FIG. 5), assistance for the front-side page layout is provided. If the user chooses in advance a preferred page layout, then such layout is directly displayed. If not, the screen, as shown, displays a list of options, i.e. enabling to choose a page layout inside the terminal or to choose from the remote server, or to create a new page layout.

When selecting “Choose a page layout”, a choice is then provided between several types of page layouts, such page layouts differing in colour, in style, in size, etc.

If the user chooses the option “Create a new page layout”, a series of options are proposed which, in the example, are: the choice of the frame colour, the thickness of the frame, and the choice of a card with rounded corners and a choice of styles.

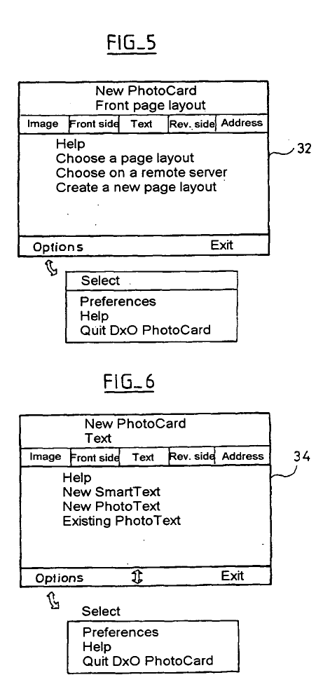

When the user clicks on the “text” tab of the screen 30 shown in FIG. 4, screen 34 from FIG. 6 then appears providing a choice between a new text of the “smart text” type (text with semi-automatic input), a new “photo-text” or an existing photo-text.

When choosing the “new text” option, the man/machine interface switches to text creation with standard input or semi-automatic input, which consists of allowing several fields for the text and reusing, in each one of the fields, texts already memorised. The first field is the header field which refers to the recipient: “Dear friend”, “Dear Mum”, etc. A second field concerns the body of the text: “It's fine today”, “Great holidays!”, etc. A third field concerns the closing of the text including the formal ending and a fourth field includes the signature.

When selecting the “photo-text” option, a screen (not illustrated) is then displayed to inform the user that he/she has to take a photo of a text, for example handwritten, with instructions for correctly taking a text photo, such as “make sure you are quite parallel” and “try to have uniform lighting”.

In an embodiment, a rectangular framing is displayed on the screen and enables to determine, depending on if it is deformed or not, whether the photograph is taken with the correct angle.

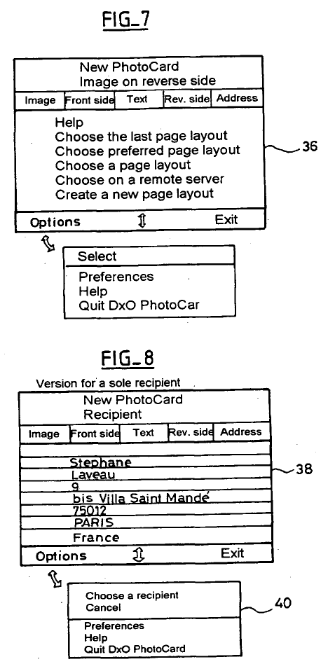

Once the text has been composed or photographed; the user can move on to the next step corresponding to the “reverse side” tab of FIG. 4, and which refers to the page layout of the reverse side, i.e. for the text. In such a case, the screen 36 in FIG. 7 is displayed and provides the following options:
choosing the last page layout,
choosing the preferred page layout,
choosing a page layout,
choosing a page layout on a remote server, and
creating a new page layout.

The choice of the page layout, which can be found, for example, in the terminal's memory, consists, in an embodiment, of choosing the type of postage stamp to be used and corresponding, for example, to the place where the photo was taken. It can also consist of choosing the background colour.

For creating a new page layout, a choice of fonts, a size of font, an overall colour and stamp are all proposed.

FIG. 8 shows the screen 38 which appears when the user chooses the “address” tab on the screen in FIG. 4. If the terminal already contains a list of contacts, then the recipient is chosen from the contacts' list using the “option” box (screen 40). If it concerns a new contact, then the screen will show several zones for the first name (which can then be chosen by making contact with option T9), the family name, the street number, the street name, the post code of the town and the country.

Preferably, when the post code is indicated, the corresponding town automatically appears, and reciprocally, when the town is indicated, the post code is automatically shown.

It is also possible to choose several recipients for a same postcard.

If the postcard is incomplete, a screen will mention that such postcard is not complete and will ask to choose an image, a recipient and a text; it will also indicate that a default front-side page layout (image) has been used and that, similarly, a default reverse-side page layout (text) has been used.

If the postcard is complete, then the sending screen indicates that the postcard is ready to be sent and proposes the user to save it as a template.

Finally, after dispatch, a screen shows that the postcard has been sent and proposes the user to send the same card to another recipient.

5. Adapting the Data to be Transmitted to the Network Transmission Capacity

The capacity of the sensors in cameraphones is constantly increasing and widely exceeds the pass-band containing the transmission protocols. For example, a VGA sensor provides 300,000 pixels and each pixel uses one octet in order to code each one of the colour channels, which provides a gross image of approximately 900 ko. However, most terminals are only capable of sending files, once compressed, of 30 to 50 ko, i.e. approximately 3 to 5% of the initial data in the case of a VGA sensor.

Based on such observation, the invention proposes a method which enables to optimise the image quality transmitted due to a protocol which enables to choose, in light of such optimisation, the rate of the sub-sampling, and the compression parameters, namely of the JPEG type.

It is in fact known that, in order to reduce the image file size, sub-sampling can be done on the one hand, while it can be compressed on the other using a compression algorithm, such as the JPEG algorithm.

Subsequent sub-sampling and re-sampling reduce the resolution and entail a loss of detail as well as aliasing.

Furthermore, the JPEG compression leads to a loss of information and causes the appearance of artefacts (defects), which are all the more important as the compression rate is high.

Having said that, the loss of resolution caused by re-sampling may no longer be corrected. On the other hand, the artefacts caused by JPEG compression have an organised and known distribution which enables them to be corrected within a certain limit. Such correction is performed, for example, by smoothing the unit edges as described in the JPEG standard or even by an algorithm known as the “JPEG CLEANER” enabling to decompress and correct such defects.

In order to determine the compression rate and the sampling rate, the chart shown in FIG. 9 is used where is indicated the compression rate in abscissae and the sampling rate in ordinates.

Such chart comprises three curves corresponding to three different images.

The chart is obtained in the following manner: three test images are selected which represent at the outset a 1 mega pixel definition.

Using such images, copies compressed at different rates are generated, thus enabling to obtain files of a given size: 200 ko, 150 ko, 100 ko, 80 ko, 60 ko, 55 ko, 50 ko, 45 ko, 40 ko, 35 ko, etc., re-sampled in advance, the sampling rate being by 90%, 80%, 70%, 60%, etc., the sampling rate being the same whether being in horizontal or vertical direction.

The images are then categorised by file size and each group of files is thus comprised of images having the same size, though with varying definitions.

In order to be able to compare the different images thus obtained, such images were put back into the definition of the original by way of an interpolation calculation of the bi-cubic type.

Next, for each series of images, an experienced viewer observed the various images on a computer screen and determined the image that he/she judged the most satisfactory compared with a file of similar size, while noting of course, the sub-sampling rate and the corresponding compression factor.

It was noted that the association of the JPEG compression to image re-sampling enables to obtain better results than either of the methods used separately.

Hence it was noted that the chart in FIG. 9 enables to choose, for a given compression rate, the value of the sampling rate providing the best image quality.

In the chart shown in FIG. 10, the ko image file size is stated in abscissae, while the sampling rate is stated in ordinates. The curves illustrated in this FIG. 10 show the most satisfactory image according to the file size and the sampling rate.

Based on a 1 mega pixel image which represents approx 3 Mo in size without compression, for the purpose of obtaining a 30 ko file, it is preferable to sub-sample the image by 50% (which corresponds to a 4-factor reduction in the number of pixels) prior to image compressing. To obtain a 50 ko file, it is advisable to sub-sample the image by 70% (i.e. a 2-factor reduction in the number of pixels) prior to image compressing. Finally, for a file exceeding 130 ko, it is preferable to use only a JPEG compression, without sub-sampling.

In practice, the mobile telephone terminal contains in the memory the charts shown in FIGS. 9a and 10a, also known as ? within the meaning of the invention, i.e. the optimal compression curve according to the size of the multimedia data. FIG. 9a represents a chart with a 50 curve constituting an average of all the curves in FIG. 9, while the chart in FIG. 10a contains a 52 curve corresponding to an average value of the curves in FIG. 10.

Thus, in order to determine the file that should be sent over the network, an algorithm linked to the file size is programmed inside the mobile telephone terminal, which can be transmitted by the latter over the network. This file size in abscissae in FIG. 10a corresponds to a sampling rate in ordinates in the same figure. Such sampling rate enables to determine, using the 50 curve from FIG. 9a, a compression rate in abscissae from FIG. 9a. This algorithm is represented by the arrows leaving from point A in abscissae in FIG. 10a to reach point B in abscissae in FIG. 9a.

However, the compression rate obtained can provide a file size exceeding that supported by the network, as, for a given compression rate, the final file size shall depend upon the amount of details contained in the image. This is why, in such a case, the algorithm selects a higher compression rate B′, which enables to select a corresponding sampling rate due to the 50 curve of FIG. 9a and to verify, using the chart in FIG. 10a, whether the file size A′ is lower than the maximum allowed by the network. Such repetitive procedure continues if size A′ is still too large, i.e. by selecting a file size A″, lower than A′, until achieving a satisfactory file size.

Of course, the optimal compression curve depending on the multimedia data size can be represented inside the terminal's memory in the form of charts from FIGS. 9a and 10a, but also as value tables or algorithms.

And of course, only the necessary part of the optimal compression curve could be represented inside the terminal's memory depending on the size of the multimedia data. The necessary part being, for example, the extract corresponding to the maximum file sizes able to transit by the networks of the various telephone operators.

1-21. (canceled)

22. A method to improve quality of using a service relating to at least one type of multimedia data, namely relating to photos, and/or video, and/or audio, and/or text, implementing at least one process for such data; such service being proposed by a service provider and/or a telecommunications' operator inside a user's mobile telephone via a network, the mobile telephone being connected to a remote server via the network; the method comprising:
inside the mobile telephone, a compression for the multimedia data, such compression including pre-processing to optimize size of the multimedia data, a compression rate applied, and its format, such pre-processing depending upon specifications of the network transmission, and an optimal compression curve depending on the size of the multimedia data,
wherein the compression is preferably implemented within the frequency domain.

23. A method according to claim 22, in which the pre-processing depends upon the type of service required and/or the type of the multimedia data compression.

24. A method according to claim 22 further comprising decompression with, preferably, an elimination process of artefacts or defects linked to compression.

25. A method according to claim 22 in which, the multimedia data is of digital type, and a compression rate and a sampling rate are determined using the optimal predetermined compression curve.

26. A method according to claim 22, in which the optimal compression curve is contained inside a memory of the mobile telephone in a form of one or plural charts.

27. A method according to claim 22, in which the optimal compression curve is contained inside a memory of the mobile telephone in a form of a value or algorithm tables.

28. A method according to claim 22, in which the compression includes:
using a first pre-determined chart, to determine a rate of sampling to be used depending on a size of the data to be compressed;
using a second chart, to determine a rate of compression to be used according to the rate of sampling determined previously; such first and second charts forming the optimal compression curve;
in a case that a size of the multimedia data obtained after compression exceeds a size supported by the network, a compression rate higher than the rate determined is chosen, and using the second chart, the corresponding sampling rate is chosen, and using the first chart, the size of the multimedia data obtained at the end of the compression carried out with the new rate is determined;
this last operation being repeated until achieving a satisfactory file size.

29. A mobile telephone terminal comprising:
means for improving quality of using a service relating to at least one type of multimedia data, namely relating to photos, and/or video, and/or audio, and/or text, implementing at least one process for such data; such service being proposed by a service provider and/or a telecommunications' operator inside a user's mobile telephone via a network, the mobile telephone being connected to a remote server via the network;
the means for improving including, means for compressing the multimedia data, for example, means of the JPEG type, such compression means including pre-processing means to optimize a size of the multimedia data, the compression rate applied, and its format, such pre-processing depending upon specifications of the network transmission, and an optimal compression curve according to the size of the multimedia data;
the compression preferably being implemented within the frequency domain.

30. A mobile telephone terminal according to claim 29, including pre-processing means for optimizing the size of the multimedia data, such pre-processing depending upon the type of service required and/or the type of the multimedia data compression.

31. A mobile telephone terminal according to claim 29, including, in a case that the multimedia data is of digital type, means for determining a compression rate and a sampling rate using the predetermined optimal compression curve.

32. A mobile telephone terminal according to claim 29, including a memory containing the optimal compression curve in a form of one or plural charts.

33. A mobile telephone terminal according to claim 29, including a memory containing the optimal compression curve in a form of a value or algorithm tables.

34. A mobile telephone terminal according to claim 29, in which the means for compression includes:
means for determining, using a first predetermined chart, the sampling rate to be used depending on the size of the data to be compressed;
means for determining, using a second chart, the compression rate to be used according to the sampling rate determined previously; such first and second charts forming the optimal compression curve;
means for, in a case that the size of the multimedia data obtained after compression exceeds the size supported by the network, choosing a compression rate higher than the rate determined; selecting, using the second chart, the corresponding sampling rate; and determining, using the first chart, the size of the multimedia data obtained at the end of the compression step carried out with the new rate;
the last means being used repeatedly until achieving a satisfactory file size.

35. A server of a mobile telephone telecommunications' network comprising:
means for improving quality of using a service relating to at least one type of multimedia data, namely relating to photos, and/or video, and/or audio, and/or text, implementing at least one process for such data,
the means for improving the quality of use including means for decompression with means for processing elimination of artefacts or faults linked to a compression.
